(19) United States
(12) Patent Application Publication
(10) Pub. No.: US 2025/0376164 A1
(43) Pub. Date: Dec. 11, 2025

(54) PROCESSING APPARATUS

(71) Applicant: SUBARU CORPORATION, Tokyo (JP)

(72) Inventors: Takehiko KATSURANO, Tokyo (JP); Yusuke OKUBO, Tokyo (JP); Shinji SAWADA, Tokyo (JP); Yoshiaki MAEZAWA, Tokyo (JP); Takahiro UEKI, Tokyo (JP); Takahito FUJINO, Tokyo (JP); Ryuya SUZUKI, Tokyo (JP); Norio SUZUKI, Tokyo (JP)

(21) Appl. No.: 19/307,679

(22) Filed: Aug. 22, 2025

Related U.S. Application Data
(63) Continuation of application No. PCT/JP2024/010365, filed on Mar. 15, 2024.

(30) Foreign Application Priority Data
Mar. 16, 2023 (WO) PCT/JP2023/010403

(51) Int. Cl. B60W 30/16; B60W 30/165; B60W 30/182

(52) U.S. Cl. CPC B60W 30/162; B60W 30/165; B60W 30/182; B60W 2552/30; B60W 2554/802; B60W 2555/60

(57) ABSTRACT

A processing apparatus includes one or more processors and one or more memories coupled to the one or more processors. The one or more processors are configured to, in a following-travel mode in which a driver who drives a vehicle follows a preceding vehicle, execute a process including: setting a target vehicle speed depending on a traveling environment for the vehicle to a vehicle speed depending on a vehicle speed of the preceding vehicle; and identifying consumption characteristics of an energy resource of the vehicle based on an amount of deviation of an actual vehicle speed of the vehicle from the target vehicle speed.

### CROSS-REFERENCE TO RELATED APPLICATIONS

This application is continuation of International Application No. PCT/JP2024/010365, filed on Mar. 15, 2024 that claims priority from PCT/JP2023/010403 filed on Mar. 16, 2023, the entire contents of which are hereby incorporated by reference.

### BACKGROUND

The disclosure relates to a processing apparatus.

A vehicle travels by consuming an energy resource in the vehicle. For example, an electric automobile uses as the energy resource electric power stored in a battery. To assist a driver who drives the vehicle, an amount of energy resource consumed by the vehicle is estimated. For example, Japanese Unexamined Patent Application Publication No. 2012-220415 discloses a technique for estimating a cruising range of a vehicle by estimating an amount of energy resource consumed by the vehicle.

### SUMMARY

According to an aspect of the disclosure, a processing apparatus includes one or more processors and one or more memories coupled to the one or more processors. The one or more processors are configured to, in a following-travel mode in which a driver who drives a vehicle follows a preceding vehicle, execute a process including: setting a target vehicle speed depending on a traveling environment for the vehicle to a vehicle speed depending on a vehicle speed of the preceding vehicle; and identifying consumption characteristics of an energy resource of the vehicle based on an amount of deviation of an actual vehicle speed of the vehicle from the target vehicle speed.

According to an aspect of the disclosure, a processing apparatus includes one or more processors and one or more memories coupled to the one or more processors. The one or more processors are configured to, while a vehicle is turning, execute a process including: setting a target vehicle speed depending on a traveling environment for the vehicle to a vehicle speed depending on a radius of curvature of a road on which the vehicle is traveling; and identifying consumption characteristics of an energy resource of the vehicle based on an amount of deviation of an actual vehicle speed of the vehicle from the target vehicle speed.

According to an aspect of the disclosure, a processing apparatus includes one or more processors and one or more memories coupled to the one or more processors. The one or more processors are configured to, in a non-following-travel mode in which a driver who drives a vehicle does not follow a preceding vehicle, execute a process including: setting a target vehicle speed depending on a traveling environment for the vehicle to a vehicle speed depending on a legally permitted speed for a road on which the vehicle is traveling; and identifying consumption characteristics of an energy resource of the vehicle based on an amount of deviation of an actual vehicle speed of the vehicle from the target vehicle speed. The vehicle includes a surrounding-environment sensor configured to detect surrounding-environment information regarding an environment surrounding the vehicle. The one or more processors are configured to, when the surrounding-environment sensor does not detect the preceding vehicle or when the surrounding-environment sensor detects the preceding vehicle and a following distance between the vehicle and the preceding vehicle is equal to or greater than a predetermined distance, determine that the vehicle is in the non-following-travel mode in which the vehicle does not follow the preceding vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a general configuration of a vehicle according to an embodiment of the disclosure;

FIG. 2 is a block diagram illustrating an example of a functional configuration of a processing apparatus according to the embodiment of the disclosure;

FIG. 3 is a flowchart illustrating a first example of a process performed by the processing apparatus according to the embodiment of the disclosure;

FIG. 4 is a diagram for describing a process of acquiring first operation-characteristics information and a process of identifying first consumption characteristics, the processes being performed by the processing apparatus according to the embodiment of the disclosure; and

FIG. 5 is a flowchart illustrating a second example of a process performed by the processing apparatus according to the embodiment of the disclosure.

### DETAILED DESCRIPTION

To assist a driver who drives a vehicle, estimating consumption characteristics of an energy resource of the vehicle with higher accuracy is desirable.

It is desirable to provide a processing apparatus capable of estimating consumption characteristics of an energy resource of a vehicle with higher accuracy.

An embodiment of the disclosure will be described in detail hereinafter with reference to the attached drawings. Parameters such as dimensions, materials, and numerical values provided in the embodiment are merely examples for easier understanding of the disclosure and are not intended to limit the disclosure, unless otherwise specified. In the specification and the drawings, elements that have substantially the same functions and constituents are denoted by the same symbols and are not redundantly described, and elements not directly relevant to the disclosure are omitted from the drawings.

### Configuration of Vehicle

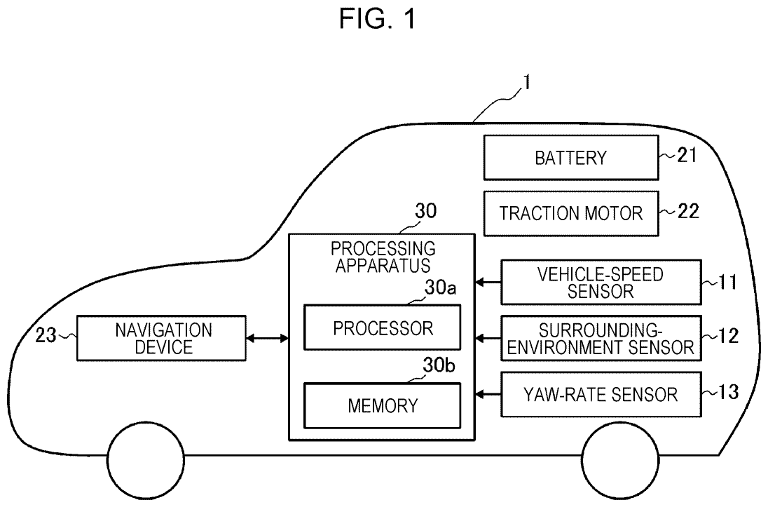

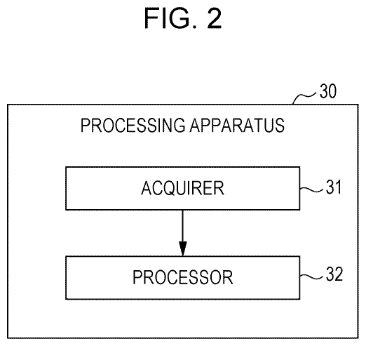

Referring to FIG. 1 and FIG. 2, a configuration of a vehicle 1 according to an embodiment of the disclosure will be described.

FIG. 1 is a schematic diagram illustrating a general configuration of the vehicle 1. In the following description, an example will be described in which the vehicle 1 is an electric automobile including a battery 21 and travels using electric power stored in the battery 21 as an energy resource. That is, in the following example, a travel distance per unit capacity of the energy resource corresponds to an electric-power consumption rate.

However, the energy resource of the vehicle 1 is not limited to the electric power stored in the battery 21. For example, the vehicle 1 may be an engine-driven vehicle including an engine and may travel using fuel supplied to the engine as an energy resource. In this case, the travel distance per unit capacity of the energy resource corresponds to a fuel consumption rate.

As illustrated in FIG. 1, the vehicle 1 includes a vehicle-speed sensor 11, a surrounding-environment sensor 12, a yaw-rate sensor 13, the battery 21, a traction motor 22, a navigation device 23, and a processing apparatus 30. The vehicle-speed sensor 11 is configured to detect a vehicle speed that is a speed of the vehicle 1.

The surrounding-environment sensor 12 is configured to detect surrounding-environment information regarding an environment surrounding the vehicle 1. Examples of the surrounding-environment sensor 12 include a camera, a radar, and an ultrasonic sensor. In one example, the surrounding-environment sensor 12 is disposed at the front of the vehicle 1 and is configured to detect surrounding-environment information in front of the vehicle 1. For example, the surrounding-environment sensor 12 is configured to detect, as the surrounding-environment information, information regarding a behavior of a preceding vehicle traveling ahead of the vehicle 1. Examples of the information regarding a behavior include a speed and an acceleration. For example, the surrounding-environment sensor 12 is also configured to detect information regarding a positional relationship between a road on which the vehicle 1 travels and the vehicle 1 as the surrounding-environment information. Examples of the information regarding the positional relationship include information indicating which travel lane the vehicle 1 is traveling in and information indicating where in the travel lane the vehicle 1 is traveling.

The yaw-rate sensor 13 is configured to detect a yaw rate generated in the vehicle 1.

The battery 21 may be charged with electric power and discharged. Examples of the battery 21 include a lithium ion battery, a lithium ion polymer battery, a nickel-hydrogen battery, a nickel-cadmium battery, and a lead storage battery, but a battery other than these may be used. The battery 21 stores electric power to be supplied to the traction motor 22.

The traction motor 22 is configured to output power to be transmitted to the wheels of the vehicle 1, and is, for example, a three-phase alternating-current motor. The traction motor 22 is driven by the electric power from the battery 21 to output power. The traction motor 22 is also regeneratively driven while the vehicle 1 is decelerated and is able to generate electric power using kinetic energy of the wheels. In this case, the electric power generated by the traction motor 22 is supplied to the battery 21. Thus, the battery 21 is charged with the electric power generated by the traction motor 22.

The navigation device 23 is configured to present a driving route from the current location of the vehicle 1 to a destination requested by a user in response to an input operation by a driver who drives the vehicle 1. The navigation device 23 is configured to determine a driving route to recommend selected from multiple candidates for the driving route and suggest the selected driving route to recommend to the user. In the present specification, the driving route to recommend is a driving route for which consumption of the energy resource is reduced. With reference to the driving route to recommend, the driver selects from the multiple candidates for the driving route a driving route along which the navigation device 23 is caused to guide the driver.

In one example, the navigation device 23 visually displays information and is configured to display various kinds of information related to route guidance. Examples of the information displayed by the navigation device 23 include the current location of the vehicle 1, a driving route along which the driver is to be guided, the location of a destination, the distance from the current location of the vehicle 1 to the destination along the driving route, and the arrival time at the destination. The navigation device 23 is able to acquire information indicating the current location of the vehicle 1 based on a signal transmitted from a global positioning system (GPS) satellite.

The processing apparatus 30 includes one or more processors 30a and one or more memories 30b coupled to the one or more processors 30a. Examples of the one or more processors 30a include a central processing unit (CPU). Examples of the one or more memories 30b include a read only memory (ROM) and a random access memory (RAM). The ROM is a storing device configured to store a program and data such as computation parameters to be used by the CPU. The RAM is a storing device configured to temporarily store data such as variables and parameters to be used for a process executed by the CPU.

The processing apparatus 30 is configured to communicate with each device in the vehicle 1 such as the vehicle-speed sensor 11, the surrounding-environment sensor 12, the yaw-rate sensor 13, and the navigation device 23. Communication between the processing apparatus 30 and each device is achieved by using, for example, controller area network (CAN) communication.

FIG. 2 is a block diagram illustrating an example of a functional configuration of the processing apparatus 30. For example, as illustrated in FIG. 2, the processing apparatus 30 includes an acquirer 31 and a processor 32. The one or more processors 30a are able to execute various processes including a process that is described below and that is performed by the acquirer 31 or the processor 32. In detail, the one or more processors 30a are configured to execute programs stored in the one or more memories 30b and thereby perform various processes.

The acquirer 31 is configured to acquire various kinds of information and output the information to the processor 32. For example, the acquirer 31 is configured to acquire information from the vehicle-speed sensor 11, the surrounding-environment sensor 12, the yaw-rate sensor 13, and the navigation device 23. In this specification, the acquisition of information may include operation such as extraction or generation of information. The generation of information is, for example, computation.

The processor 32 is configured to perform various processes using various kinds of information acquired by the acquirer 31. The processor 32 also controls the operation of the navigation device 23.

Functions possessed by the processing apparatus 30 according to the present embodiment may be shared by multiple apparatuses, and multiple functions may be achieved by one apparatus. When the functions possessed by the processing apparatus 30 are shared by multiple apparatuses, the multiple apparatuses may be coupled to each other via a communication bus such as a CAN.

### Operation of Processing Apparatus

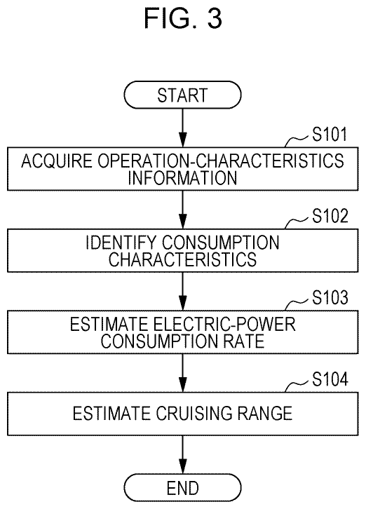

Next, operation of the processing apparatus 30 according to the embodiment of the disclosure will be described with reference to FIG. 3 to FIG. 5.

In the present embodiment, the processing apparatus 30 is configured to identify consumption characteristics of an energy resource of the vehicle 1 based on a target vehicle speed depending on a traveling environment for the vehicle 1 and an actual vehicle speed of the vehicle 1. For example, the processing apparatus 30 is configured to acquire operation-characteristics information indicating driving-operation characteristics, which are unique to the driver who drives the vehicle 1, based on the target vehicle speed depending on the traveling environment for the vehicle 1 and the actual vehicle speed of the vehicle 1, and the processing apparatus 30 is configured to identify consumption characteristics of the energy resource of the vehicle 1 based on the operation-characteristics information. Thus, as described below, the consumption characteristics of the energy resource of the vehicle 1 may be estimated with higher accuracy. In the following example, the energy resource is electric power.

The driving-operation characteristics are characteristics of driving operation exhibited by the driver who is driving the vehicle 1 and are, for example, a tendency that the driver uniquely exhibits in terms of driving operation. For example, the behavior of the vehicle 1, such as the vehicle speed, reflects the driving operation by the driver. Accordingly, the processing apparatus 30 is configured to collect information regarding the behavior of the vehicle 1 while the vehicle 1 is traveling and acquire the operation-characteristics information based on the information regarding the behavior of the vehicle 1 collected in the past. The consumption characteristics of the energy resource of the vehicle 1 are characteristics regarding consumption of the energy resource, and the characteristics originate from the driving operation unique to the driver.

Hereinafter, a first example and a second example will be described in sequence as examples of the process performed by the processing apparatus 30. Description will be given below with regard to examples in which first operation-characteristics information, second operation-characteristics information, and third operation-characteristics information are acquired as the operation-characteristics information, and first consumption characteristics, second consumption characteristics, and third consumption characteristics are identified as the consumption characteristics. However, as described below, operation-characteristics information to be acquired and consumption characteristics to be identified are not limited to the following examples.

FIG. 3 is a flowchart illustrating the first example of a process performed by the processing apparatus 30. For example, a control flow illustrated in FIG. 3 is repeatedly executed at predetermined intervals.

Once the control flow illustrated in FIG. 3 starts, the acquirer 31 first acquires operation-characteristics information in step S101. Subsequent to step S101, the processor 32 identifies consumption characteristics based on the operation-characteristics information in step S102.

Description will be given with regard to an example in which the first operation-characteristics information is acquired in step S101 and the first consumption characteristics are identified in step S102. The first operation-characteristics information indicates a tendency for the vehicle 1 to accelerate or decelerate while the vehicle 1 is traveling in a following-travel mode. The following-travel mode indicates a travel mode in which the driver who drives the vehicle 1 follows a preceding vehicle.

For example, the acquirer 31 acquires in step S101, as the first operation-characteristics information, information indicating how much the vehicle 1 accelerates or decelerates in the following-travel mode of the vehicle 1 in comparison with an ideal vehicle speed (target vehicle speed) attainable when no excessive acceleration or deceleration occurs.

The acquirer 31 determines whether the vehicle 1 is traveling in the following-travel mode, for example, based on a detection result by the surrounding-environment sensor 12. For example, the acquirer 31 is able to determine that the vehicle 1 is traveling in the following-travel mode when the surrounding-environment sensor 12 detects a preceding vehicle and a following distance between the vehicle 1 and the preceding vehicle is determined by the surrounding-environment sensor 12 to be less than a predetermined distance. The predetermined distance is, for example, 50 m.

To determine whether the vehicle 1 is traveling in the following-travel mode, the vehicle speed of the vehicle 1 may further be taken into account. For example, a condition that the vehicle speed is equal to or less than a predetermined value, for example, 40 km/h, may be added, and it may be determined whether the vehicle 1 is traveling in the following-travel mode while in a traffic jam.

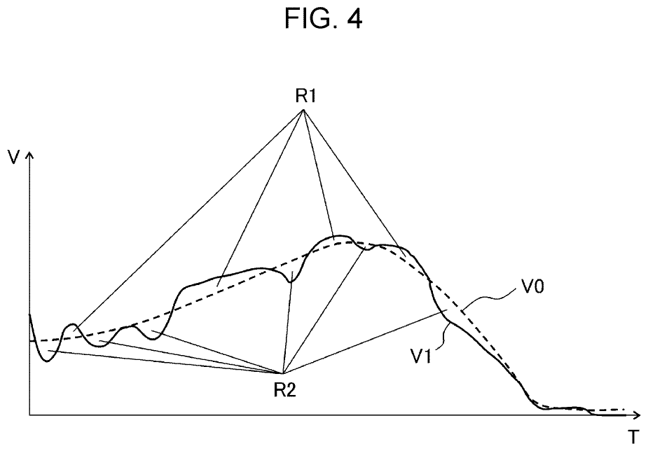

FIG. 4 is a diagram for describing a process of acquiring the first operation-characteristics information and a process of identifying the first consumption characteristics to be described below, the processes being performed by the processing apparatus 30. The horizontal axis T in FIG. 4 represents time, and the vertical axis V in FIG. 4 represents the vehicle speed. For example, the acquirer 31 first estimates a change in an ideal vehicle speed V0 involving neither excessive acceleration nor excessive deceleration based on a vehicle speed of the preceding vehicle detected by the surrounding-environment sensor 12. For example, the vehicle speed of the preceding vehicle may involve excessive acceleration or deceleration caused by a driving operation by the driver who drives the preceding vehicle. The acquirer 31 is able to estimate a change in the ideal vehicle speed V0 involving neither excessive acceleration nor excessive deceleration, for example, by applying a process using a filter such as a low-pass filter to the vehicle speed of the preceding vehicle.

The acquirer 31 then acquires, as the first operation-characteristics information, a result of comparison between a vehicle speed V1 and the ideal vehicle speed V0 in the following-travel mode, the vehicle speed V1 being an actual vehicle speed of the vehicle 1 detected by the vehicle-speed sensor 11 in the following-travel mode of the vehicle 1. For example, in a region R1 in FIG. 4, the vehicle speed V1 of the vehicle 1 is higher than the ideal vehicle speed V0, indicating that the vehicle 1 excessively accelerates. In contrast, in a region R2 in FIG. 4, the vehicle speed V1 of the vehicle 1 is lower than the ideal vehicle speed V0, indicating that the vehicle 1 excessively decelerates. For example, the acquirer 31 acquires, as the first operation-characteristics information, information such as a frequency of occurrences of the region R1, an amount of deviation of the vehicle speed V1 from the vehicle speed V0 in the region R1, a frequency of occurrences of the region R2, and an amount of deviation of the vehicle speed V1 from the vehicle speed V0 in the region R2.

After the first operation-characteristics information is acquired in step S101, the processor 32 identifies the first consumption characteristics based on the first operation-characteristics information in step S102. The first consumption characteristics are characteristics of electric-power consumption in the following-travel mode. For example, the processor 32 saves the acquired first operation-characteristics information to the one or more memories 30b in the processing apparatus 30 and identifies the first consumption characteristics using the saved first operation-characteristics information. The first consumption characteristics may thereby be identified using the information accumulated in advance.

For example, the processor 32 identifies characteristics of electric-power consumption originating from the excessive acceleration or deceleration of the vehicle 1 in the following-travel mode as the first consumption characteristics. For example, in the example in FIG. 4, the vehicle 1 unnecessarily accelerates in the area R1 due to unnecessary deceleration in the area R2. In this way, the vehicle 1 excessively accelerates or decelerates in the following-travel mode, resulting in electric-power consumption.

For example, the processor 32 estimates an amount of electric-power consumption originating from the excessive acceleration based on an amount of deviation of the vehicle speed V1 from the vehicle speed V0 in each portion of the region R1. In estimating the amount of electric-power consumption described above, the processor 32 may take the weight of the vehicle 1 into account. The processor 32 then estimates an amount of regenerated electric power obtained by the excessive deceleration based on an amount of deviation of the vehicle speed V1 from the vehicle speed V0 in each portion of the region R2. Then, the processor 32 subtracts the amount of regenerated electric power obtained by the excessive deceleration from the amount of electric-power consumption originating from the excessive acceleration, thereby estimating an amount of electric-power consumption originating from the excessive acceleration or deceleration in the following-travel mode. For example, based on the information obtained in this manner, the processor 32 identifies, as the first consumption characteristics, information indicating the amount of electric-power consumption generated per unit travel distance in the following-travel mode.

In this way, the processor 32 identifies the first consumption characteristics based on the target vehicle speed depending on the traveling environment (in the above example, the vehicle speed V0 obtained from the vehicle speed of the preceding vehicle) and the vehicle speed V1, which is the actual vehicle speed of the vehicle 1.

Subsequently, description will be given with regard to an example in which the second operation-characteristics information is acquired in step S101 and the second consumption characteristics are identified in step S102. The second operation-characteristics information indicates a tendency for the vehicle 1 to accelerate or decelerate while the vehicle 1 is turning.

For example, the acquirer 31 acquires in step S101, as the second operation-characteristics information, information indicating how much the vehicle 1 decelerates in comparison with an ideal vehicle speed (target vehicle speed) depending on a radius of curvature of the road while the vehicle 1 is turning.

The acquirer 31 determines whether the vehicle 1 is turning, for example, based on a detection result by the yaw-rate sensor 13. For example, when a yaw rate detected by the yaw-rate sensor 13 is relatively large, the acquirer 31 is able to determine that the vehicle 1 is turning.

For example, the acquirer 31 first estimates the radius of curvature of the road based on the yaw rate of the vehicle 1 detected by the yaw-rate sensor 13 and the vehicle speed of the vehicle 1 detected by the vehicle-speed sensor 11 while the vehicle 1 is turning. The acquirer 31 may estimate the radius of curvature of the road based on the surrounding-environment information acquired by the surrounding-environment sensor 12. The acquirer 31 then determines the ideal vehicle speed V0 depending on the estimated radius of curvature of the road. The ideal vehicle speed V0 is, for example, a vehicle speed obtained by multiplying a highest vehicle speed that does not cause a tire to slip during a turn by a predetermined safety factor. The highest vehicle speed is set in advance for each radius of curvature of the road, and the predetermined safety factor is, for example, 80%. In setting the highest vehicle speed described above, the acquirer 31 may take into account the weight of the vehicle 1 or a factor such as friction characteristics of the tire. The acquirer 31 then acquires, as the second operation-characteristics information, a result of comparison between the vehicle speed V1 of the vehicle 1 detected by the vehicle-speed sensor 11 while the vehicle 1 is turning and the ideal vehicle speed V0 during a turn. For example, the acquirer 31 acquires, as the second operation-characteristics information, an amount of deviation of the vehicle speed V1 from the vehicle speed V0 during a turn for each of the multiple turns.

When the second operation-characteristics information is acquired in step S101, the processor 32 identifies the second consumption characteristics based on the second operation-characteristics information in step S102. The second consumption characteristics are characteristics of electric-power consumption during a turn. For example, the processor 32 saves the acquired second operation-characteristics information to the one or more memories 30b in the processing apparatus 30 and identifies the second consumption characteristics using the saved second operation-characteristics information. The second consumption characteristics may thereby be identified using the information accumulated in advance.

For example, the processor 32 identifies characteristics of electric-power consumption originating from excessive acceleration or deceleration of the vehicle 1 during a turn as the second consumption characteristics. If the vehicle 1 unnecessarily decelerates during a turn in comparison with an ideal vehicle speed depending on the radius of curvature of the road, the vehicle 1 is to unnecessarily accelerates. In this way, the vehicle 1 excessively accelerates or decelerates during a turn, resulting in electric-power consumption.

For example, the processor 32 estimates an amount of electric-power consumption originating from excessive acceleration or deceleration during a turn based on an amount of deviation of the vehicle speed V1 of the vehicle 1 from the ideal vehicle speed V0 during a turn. In one example, the amount of electric-power consumption originating from excessive acceleration or deceleration during a turn is estimated by the processor 32 to be larger for a larger amount of deviation of the vehicle speed V1 of the vehicle 1 from the ideal vehicle speed V0 during a turn. Based on the information obtained in this manner, the processor 32 then identifies, as the second consumption characteristics for each radius of curvature, information indicating the amount of electric-power consumption generated per unit travel distance during a turn.

In this way, the processor 32 identifies the second consumption characteristics based on the target vehicle speed depending on the traveling environment (the vehicle speed V0 obtained from the radius of curvature of the road) and the vehicle speed V1, which is the actual vehicle speed of the vehicle 1.

Subsequently, description will be given with regard to an example in which the third operation-characteristics information is acquired in step S101 and the third consumption characteristics are identified in step S102. The third operation-characteristics information indicates a tendency of the vehicle speed of the vehicle 1 in a non-following-travel mode in which the driver who drives the vehicle 1 is not following any vehicle.

For example, the acquirer 31 acquires in step S101, as the third operation-characteristics information, information indicating how fast the vehicle 1 is traveling in the non-following-travel mode of the vehicle 1 in comparison with the ideal vehicle speed V0 (target vehicle speed) at which running resistance may be reduced to a certain level. The ideal vehicle speed V0 above may be set in accordance with, for example, a legally permitted speed. For example, the ideal vehicle speed V0 above is set to a legally permitted speed or a speed obtained by subtracting a predetermined value from the legally permitted speed. The acquirer 31 is able to acquire the legally permitted speed assigned to the road on which the vehicle 1 is traveling, for example, based on map data obtained from the navigation device 23 or information obtained by the surrounding-environment sensor 12 from a speed-limit sign. For example, the acquirer 31 acquires, as the third operation-characteristics information, an amount of deviation of the vehicle speed V1 of the vehicle 1 from the ideal vehicle speed V0 in the non-following-travel mode.

The acquirer 31 determines whether the vehicle 1 is not traveling in the following-travel mode, for example, based on a detection result by the surrounding-environment sensor 12. For example, the acquirer 31 is able to determine that the vehicle 1 is not traveling in the following-travel mode when the surrounding-environment sensor 12 detects no preceding vehicle or when a following distance between the vehicle 1 and the preceding vehicle is determined by the surrounding-environment sensor 12 to be equal to or greater than a predetermined distance. The predetermined distance is, for example, 50 m.

When the third operation-characteristics information is acquired in step S101, the processor 32 identifies the third consumption characteristics based on the third operation-characteristics information in step S102. The third consumption characteristics are characteristics of electric-power consumption in the non-following-travel mode. For example, the processor 32 saves the acquired third operation-characteristics information to the one or more memories 30b in the processing apparatus 30 and identifies the third consumption characteristics using the saved third operation-characteristics information. The third consumption characteristics may thereby be identified using the information accumulated in advance.

For example, the processor 32 identifies, as the third consumption characteristics, characteristics of electric-power consumption originating from the vehicle 1 traveling at a vehicle speed higher than the ideal vehicle speed V0 at which running resistance may be reduced to a certain level in the non-following-travel mode. The running resistance acting on the vehicle 1 increases as the vehicle speed V1 of the vehicle 1 increases from the ideal vehicle speed V0 described above. In this way, the deviation of the vehicle speed V1 of the vehicle 1 from the ideal vehicle speed V0 generates electric-power consumption in the non-following-travel mode.

For example, the processor 32 estimates the amount of electric-power consumption originating from the deviation of the vehicle speed V1 of the vehicle 1 from the ideal vehicle speed V0 in the non-following-travel mode based on the amount of deviation of the vehicle speed V1 of the vehicle 1 from the ideal vehicle speed V0 in the non-following-travel mode. In one example, when the vehicle speed V1 of the vehicle 1 is higher than the ideal vehicle speed V0 in the non-following-travel mode, the amount of electric-power consumption originating from the deviation of the vehicle speed V1 of the vehicle 1 from the ideal vehicle speed V0 in the non-following-travel mode is estimated by the processor 32 to be larger for a larger amount of deviation of the vehicle speed V1 from the vehicle speed V0. Based on the information obtained in this manner, the processor 32 then identifies, as the third consumption characteristics for each speed, information indicating the amount of electric-power consumption generated per unit travel distance in the non-following-travel mode.

In this way, the processor 32 identifies the third consumption characteristics based on the target vehicle speed depending on the traveling environment (the vehicle speed V0 obtained from the legally permitted speed for the road) and the vehicle speed V1, which is the actual vehicle speed of the vehicle 1.

Subsequent to step S102, the processor 32 estimates an electric-power consumption rate of the vehicle 1 in step S103.

In step S103, the processor 32 estimates the electric-power consumption rate of the vehicle 1 based on the consumption characteristics identified in step S102. For example, when a subset of the first consumption characteristics, the second consumption characteristics, and the third consumption characteristics is identified in step S102, the processor 32 estimates the electric-power consumption rate of the vehicle 1 in step S103 based on the identified subset of the consumption characteristics. For example, when all of the first consumption characteristics, the second consumption characteristics, and the third consumption characteristics are identified in step S102, the processor 32 estimates the electric-power consumption rate of the vehicle 1 in step S103 based on all of the first consumption characteristics, the second consumption characteristics, and the third consumption characteristics. In one example, the processor 32 makes an adjustment to the standard electric-power consumption rate of the vehicle 1 and estimates the electric-power consumption rate of the vehicle 1. The adjustment involves each type of the above-mentioned consumption characteristics that represent characteristics of the energy-resource consumption originating from the driving operation unique to the driver, whereas the standard electric-power consumption rate of the vehicle 1 does not involve the driving operation unique to the driver.

For example, in estimating the electric-power consumption rate involving the first consumption characteristics, the processor 32 first predicts a region in which the vehicle 1 travels in the following-travel mode on the driving route. In one example, using traffic jam information obtained from the navigation device 23, the processor 32 predicts that the vehicle 1 will travel in the following-travel mode in a region where a traffic jam has occurred on the driving route. The processor 32 then estimates the electric-power consumption rate of the vehicle 1 on the assumption that the vehicle 1 travels in the following-travel mode in the region where the vehicle 1 is predicted to travel in the following-travel mode and that electric power is consumed in accordance with the first consumption characteristics.

In one example, in estimating the electric-power consumption rate involving the second consumption characteristics, the processor 32 first determines a path length of each bend on the driving route. For example, the processor 32 determines the path length of each bend having a respective radius of curvature on the driving route using the map data obtained from the navigation device 23. The processor 32 then estimates the electric-power consumption rate of the vehicle 1 on the assumption that electric power is consumed on each bend in accordance with the second consumption characteristics.

For example, in estimating the electric-power consumption rate involving the third consumption characteristics, the processor 32 first predicts a region in which the vehicle 1 does not travel in the following-travel mode on the driving route. In one example, using traffic jam information obtained from the navigation device 23, the processor 32 predicts that the vehicle 1 will not travel in the following-travel mode in a region where a traffic jam has not occurred on the driving route. The processor 32 then estimates the electric-power consumption rate of the vehicle 1 on the assumption that the vehicle 1 does not travel in the following-travel mode in the region where the vehicle 1 is predicted not to travel in the following-travel mode and that electric power is consumed in accordance with the third consumption characteristics.

Subsequent to step S103, the processor 32 estimates a cruising range of the vehicle 1 based on the electric-power consumption rate of the vehicle 1 in step S104, and the control flow illustrated in FIG. 3 ends.

In step S104, for example, the processor 32 estimates the cruising range of the vehicle 1 based on a remaining capacity of the battery 21 and the electric-power consumption rate of the vehicle 1. In one example, the processor 32 is able to estimate the cruising range to be a value obtained by multiplying the remaining capacity of the battery 21 by the electric-power consumption rate. The processor 32 then notifies the driver of the cruising range, for example, by causing the navigation device 23 to display the cruising range.

For example, the processor 32 is able to save information regarding the consumption characteristics identified in step S102 to the one or more memories 30b in the processing apparatus 30 and is able to estimate the electric-power consumption rate in step S103 and the cruising range in step S104 using the saved information regarding the consumption characteristics. Thus, for example, the electric-power consumption rate and the cruising range are appropriately estimated based on multiple types of consumption characteristics. In one example, when the system of the vehicle 1 is turned on, the electric-power consumption rate and the cruising range are appropriately estimated using the information regarding the consumption characteristics accumulated in the past.

As described above, in the first example, the processing apparatus 30 is configured to identify the consumption characteristics of the energy resource of the vehicle 1 based on the target vehicle speed depending on the traveling environment for the vehicle 1 and the actual vehicle speed of the vehicle 1. For example, the processing apparatus 30 is configured to acquire the operation-characteristics information indicating the driving-operation characteristics, which are unique to the driver who drives the vehicle 1, and is configured to identify the consumption characteristics of the energy resource of the vehicle 1 based on the operation-characteristics information. The consumption characteristics due to the traveling environment may be grasped in this way, and thus the consumption characteristics of the energy resource of the vehicle 1 may accurately be estimated. In the first example, the processing apparatus 30 is configured to estimate the cruising range of the vehicle 1 based on the consumption characteristics of the energy resource. Thus, the cruising range of the vehicle 1 may accurately be estimated.

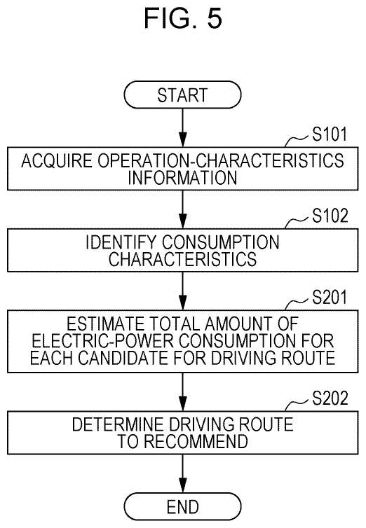

FIG. 5 is a flowchart illustrating the second example of a process performed by the processing apparatus 30. For example, a control flow illustrated in FIG. 5 is repeatedly executed at predetermined intervals.

In the control flow illustrated in FIG. 5, step S103 and step S104 in the control flow illustrated in FIG. 3 described above are replaced with step S201 and step S202, respectively.

In the control flow illustrated in FIG. 5, subsequent to step S102, the processor 32 estimates the total amount of electric-power consumption for each candidate for the driving route in step S201. For example, the processor 32 estimates the total amount of consumption of electric power supplied from the battery 21 during traveling along each candidate for the driving route. A candidate for the driving route is extracted by the navigation device 23, for example, based on the current location of the vehicle 1 and the destination requested by the user.

In step S201, the processor 32 estimates the total amount of electric-power consumption for each candidate for the driving route based on the consumption characteristics identified in step S102. For example, the total amount of electric-power consumption for each candidate for the driving route is estimated by the processor 32 to be the total amount of electric power consumed while the vehicle 1 travels along the candidate for the driving route at an electric-power consumption rate expected after an adjustment is made to the standard electric-power consumption rate of the vehicle 1. The adjustment involves each type of the above-mentioned consumption characteristics that represent characteristics of the energy-resource consumption originating from the driving operation unique to the driver, whereas the standard electric-power consumption rate of the vehicle 1 does not involve the driving operation unique to the driver. The process regarding the estimate of the electric-power consumption rate with each type of consumption characteristics taken into account is the same as or similar to the process in step S103 in FIG. 3. However, in step S201, the processor 32 may estimate the total amount of electric-power consumption for each candidate for the driving route based on each type of consumption characteristics without estimating the electric-power consumption rate of the vehicle 1.

Subsequent to step S201, the processor 32 determines a driving route to recommend in step S202, and the control flow illustrated in FIG. 5 ends. As described above, the driving route to recommend is a driving route in which electric-power consumption is reduced. In other words, in step S202, the processor 32 designates, as the driving route to recommend, a candidate for the driving route for which the total amount of electric-power consumption is estimated to be smallest. The processor 32 then notifies the driver of the driving route to recommend, for example, by causing the navigation device 23 to display the driving route to recommend.

As described above, in the second example, as in the first example described above, the consumption characteristics of the energy resource of the vehicle 1 are identified based on the target vehicle speed depending on the traveling environment for the vehicle 1 and the actual vehicle speed of the vehicle 1, and thus the consumption characteristics of the energy resource of the vehicle 1 may be accurately estimated. In the second example, based on the consumption characteristics of the energy resource, the processing apparatus 30 determines the driving route to recommend in which the consumption of the energy resource is reduced. Thus, the driving route to recommend may appropriately be determined.

In the above description, the first example and the second example have been described as the examples of the process performed by the processing apparatus 30 with reference to the flowchart in FIG. 3 and the flowchart in FIG. 5. However, the process performed by the processing apparatus 30 is not limited to the above examples.

For example, in the first example and the second example, the acquirer 31 may refrain from acquiring any subset of the first operation-characteristics information, the second operation-characteristics information, and the third operation-characteristics information. In this case, in the first example and the second example, the processor 32 does not identify the consumption characteristics corresponding to operation-characteristics information that is not acquired among the first operation-characteristics information, the second operation-characteristics information, and the third operation-characteristics information.

For example, in the first example and the second example, the acquirer 31 may acquire operation-characteristics information other than the first operation-characteristics information, the second operation-characteristics information, and the third operation-characteristics information. The operation-characteristics information indicates characteristics of various driving operations under various situations, and examples of the operation-characteristics information may include information indicating a tendency of a steering angle under a situation in which the vehicle 1 is not changing lanes and information indicating a tendency for the vehicle 1 to accelerate or decelerate at a time of lane change.

For example, the processing apparatus 30 may estimate the cruising range of the vehicle 1 based on the consumption characteristics of the energy resource as in the first example and may determine the driving route to recommend based on the consumption characteristics above as in the second example.

### Effects of Processing Apparatus

Subsequently, effects of the processing apparatus 30 according to the embodiment of the disclosure will be described.

The one or more processors 30a in the processing apparatus 30 according to the present embodiment are configured to execute a process of identifying the consumption characteristics of the energy resource of the vehicle 1 based on the target vehicle speed depending on the traveling environment for the vehicle 1 and the actual vehicle speed of the vehicle 1. The consumption characteristics due to the traveling environment may be grasped in this way, and thus the consumption characteristics of the energy resource of the vehicle 1 may accurately be estimated.

The one or more processors 30a in the processing apparatus 30 according to the present embodiment may be configured to execute a process including estimating the cruising range of the vehicle 1 based on the consumption characteristics. Thus, the cruising range of the vehicle 1 may be estimated with higher accuracy since the cruising range of the vehicle 1 may be estimated using the consumption characteristics of the energy resource depending on the traveling environment for the vehicle 1.

The one or more processors 30a in the processing apparatus 30 according to the present embodiment may be configured to execute a process including determining, based on the consumption characteristics, a driving route to recommend in which consumption of the energy resource is reduced. Thus, the driving route to recommend may appropriately be determined since the driving route to recommend may be determined using the consumption characteristics of the energy resource depending on the traveling environment for the vehicle 1.

The one or more processors 30a in the processing apparatus 30 according to the present embodiment may be configured to, while the vehicle 1 is traveling in the following-travel mode in which the vehicle 1 is following a preceding vehicle, set a target vehicle speed to a vehicle speed depending on the vehicle speed of the preceding vehicle and execute a process of identifying the consumption characteristics based on the amount of deviation of an actual vehicle speed from the target vehicle speed. The consumption characteristics due to the following-travel mode may be grasped in this way, and thus the consumption characteristics of the energy resource of the vehicle 1 may be estimated with higher accuracy.

In the example in which the one or more processors 30a identify the consumption characteristics in the following-travel mode, the one or more processors 30a may determine that the vehicle 1 is traveling in the following-travel mode when the surrounding-environment sensor 12 detects a preceding vehicle and a following distance between the vehicle 1 and the preceding vehicle is less than a predetermined distance. Thus, it is possible to appropriately determine whether the vehicle 1 is traveling in the following-travel mode by using the surrounding-environment information detected by the surrounding-environment sensor 12.

The one or more processors 30a in the processing apparatus 30 according to the present embodiment may be configured to, while the vehicle 1 is turning, set a target vehicle speed to a vehicle speed depending on the radius of curvature of the road on which the vehicle 1 is traveling and execute a process of identifying the consumption characteristics based on the amount of deviation of an actual vehicle speed from the target vehicle speed. The consumption characteristics due to the turn may be grasped in this way, and thus the consumption characteristics of the energy resource of the vehicle 1 may be estimated with higher accuracy.

In the example in which the one or more processors 30a identify the consumption characteristics during a turn, a target vehicle speed may be set based on the highest vehicle speed that does not cause a tire of the vehicle 1 to slip, the highest vehicle speed being set depending on the radius of curvature of the road. The consumption characteristics due to a turn may appropriately be grasped in this way, and thus the consumption characteristics of the energy resource of the vehicle 1 may be estimated with higher accuracy.

The one or more processors 30a in the processing apparatus 30 according to the present embodiment may be configured to, while the vehicle 1 is traveling in the non-following-travel mode in which the vehicle 1 is not following a preceding vehicle, set a target vehicle speed to a vehicle speed depending on a legally permitted speed for a road on which the vehicle 1 is traveling and execute a process of identifying the consumption characteristics based on the amount of deviation of an actual vehicle speed from the target vehicle speed. The consumption characteristics due to the non-following-travel mode may be grasped in this way, and thus the consumption characteristics of the energy resource of the vehicle 1 may be estimated with higher accuracy.

In the example in which the one or more processors 30a identifies the consumption characteristics in the non-following-travel mode, the one or more processors 30a may determine that the vehicle 1 is not traveling in the following-travel mode when the surrounding-environment sensor 12 has not detected a preceding vehicle or when the surrounding-environment sensor 12 has detected a preceding vehicle and a following distance between the vehicle 1 and the preceding vehicle is equal to or greater than a predetermined distance. Thus, it is possible to appropriately determine whether the vehicle 1 is traveling in the following-travel mode by using the surrounding-environment information detected by the surrounding-environment sensor 12.

Although the embodiment of the disclosure has been described with reference to the accompanying drawings, it is to be understood that the disclosure is not limited to the embodiment described above, and various modifications or corrections within the scope of the appended claims are also encompassed in the technical scope of the disclosure.

For example, the processes described with reference to the flowcharts in the present specification are not necessarily to be executed in the order described in the flowcharts. An additional processing step may be adopted, and a subset of the processing steps may be omitted.

According to the disclosure, consumption characteristics of an energy resource of a vehicle may be estimated with higher accuracy.

The processing apparatus 30 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the processing apparatus 30 including the acquirer 31 and the processor 32. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A processing apparatus comprising:
one or more processors; and
one or more memories coupled to the one or more processors, wherein
the one or more processors are configured to, in a following-travel mode in which a driver who drives a vehicle follows a preceding vehicle, execute a process comprising: setting a target vehicle speed depending on a traveling environment for the vehicle to a vehicle speed depending on a vehicle speed of the preceding vehicle; and identifying consumption characteristics of an energy resource of the vehicle based on an amount of deviation of an actual vehicle speed of the vehicle from the target vehicle speed.

2. The processing apparatus according to claim 1, wherein
the vehicle comprises a surrounding-environment sensor configured to detect surrounding-environment information regarding an environment surrounding the vehicle, and
the one or more processors are configured to, when the surrounding-environment sensor detects the preceding vehicle and a following distance between the vehicle and the preceding vehicle is less than a predetermined distance, determine that the vehicle is in the following-travel mode in which the vehicle follows the preceding vehicle.

3. A processing apparatus comprising:
one or more processors; and
one or more memories coupled to the one or more processors, wherein
the one or more processors are configured to, while a vehicle is turning, execute a process comprising: setting a target vehicle speed depending on a traveling environment for the vehicle to a vehicle speed depending on a radius of curvature of a road on which the vehicle is traveling; and identifying consumption characteristics of an energy resource of the vehicle based on an amount of deviation of an actual vehicle speed of the vehicle from the target vehicle speed.

4. The processing apparatus according to claim 3, wherein the one or more processors are configured to set the target vehicle speed based on a highest vehicle speed that does not cause a tire of the vehicle to slip, the highest vehicle speed being set depending on the radius of curvature of the road on which the vehicle is traveling.

5. A processing apparatus comprising:
one or more processors; and
one or more memories coupled to the one or more processors, wherein
the one or more processors are configured to, in a non-following-travel mode in which a driver who drives a vehicle does not follow a preceding vehicle, execute a process comprising: setting a target vehicle speed depending on a traveling environment for the vehicle to a vehicle speed depending on a legally permitted speed for a road on which the vehicle is traveling; and identifying consumption characteristics of an energy resource of the vehicle based on an amount of deviation of an actual vehicle speed of the vehicle from the target vehicle speed,
the vehicle comprises a surrounding-environment sensor configured to detect surrounding-environment information regarding an environment surrounding the vehicle, and
the one or more processors are configured to, when the surrounding-environment sensor does not detect the preceding vehicle or when the surrounding-environment sensor detects the preceding vehicle and a following distance between the vehicle and the preceding vehicle is equal to or greater than a predetermined distance, determine that the vehicle is in the non-following-travel mode in which the vehicle does not follow the preceding vehicle.
